(19) United States
(12) Patent Application Publication
(10) Pub. No.: US 2017/0352034 A1
(43) Pub. Date: Dec. 7, 2017

(54) Transaction-Record Verification for Mobile-Payment System

(71) Applicant: Samsung Electronics Company, Ltd., Suwon City (KR)

(72) Inventor: Qianyong Yu, Burnaby (CA)

(21) Appl. No.: 15/171,946

(22) Filed: Jun. 2, 2016

(51) Int. Cl. G06Q 20/40; G06Q 20/08

(52) U.S. Cl. CPC G06Q 20/401; G06Q 20/0855

(57) ABSTRACT

In one embodiment, a method includes receiving, from a client device, a request to verify a client-side transaction record identifying a transaction involving a user of the client device. The method also includes verifying that the transaction identified in the client-side transaction record is also identified in a payment-network transaction record that is separate from the client-side transaction record. The method further includes, in response to verifying that the transaction identified in the client-side transaction record is also identified in the payment-network transaction record, publishing a verification of the transaction record. The method also includes sending, to the client device, a uniform resource identifier (URI) corresponding to a web location that includes the published verification of the transaction record.

### TECHNICAL FIELD

This disclosure generally relates to mobile-payment systems.

### BACKGROUND

A mobile device (e.g., a smartphone, smartwatch, or tablet computer) may communicate over short distances using near field communication (NFC), radio-frequency identification (RFID), or magnetic secure transmission. A mobile-payment system may refer to a payment service that allows a consumer to use a mobile device to pay for goods and services. A mobile-payment system may allow a mobile device to make a payment through a point of sale terminal using NFC, RFID, or magnetic secure transmission. For example, a NFC-enabled smartphone may perform a payment transaction using NFC card emulation in which the smartphone performs the payment by acting as a payment card.

### BRIEF DESCRIPTION OF THE DRAWINGS

FIG. 1 illustrates an example interaction diagram associated with a mobile-payment system.

FIG. 2 illustrates an example interaction diagram associated with a transaction-record verification process for a mobile-payment system.

FIG. 3 illustrates an example method for verifying a transaction record.

FIG. 4 illustrates an example computer system.

### DESCRIPTION OF EXAMPLE EMBODIMENTS

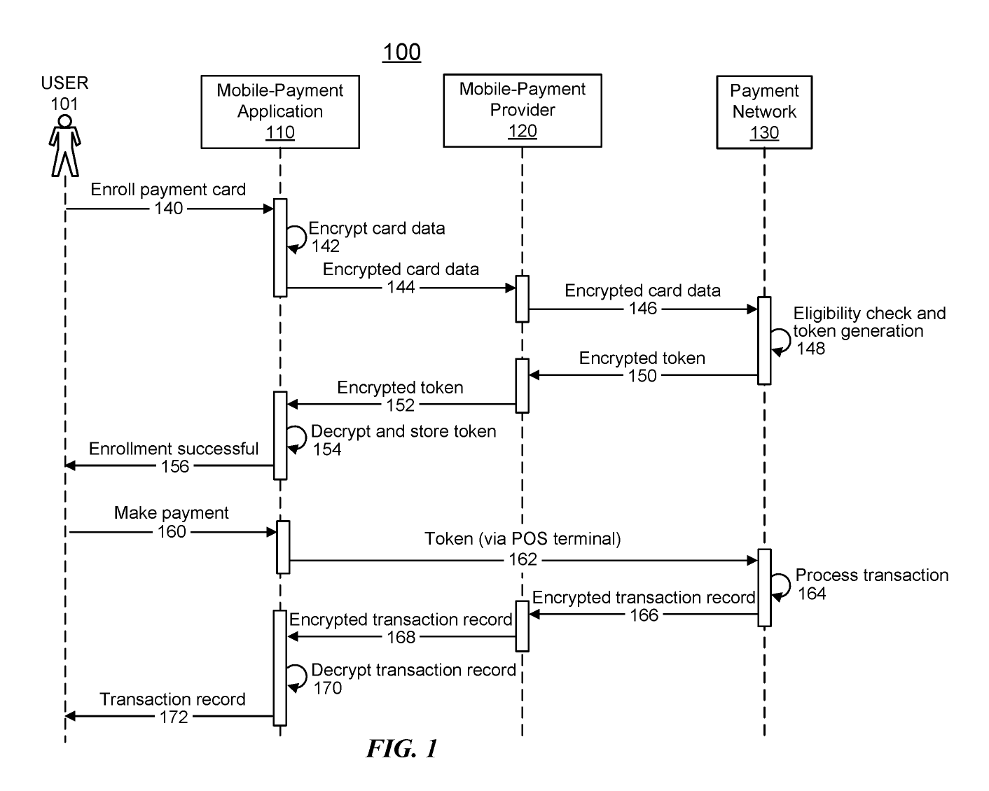

FIG. 1 illustrates an example interaction diagram 100 associated with a mobile-payment system. In particular embodiments, a mobile-payment system may include a payment framework that allows a user to use a mobile device to perform a transaction, such as for example to make a payment for a good or service. In particular embodiments, a mobile-payment system may facilitate transactions that involve mobile devices, merchants, or payment networks, and a mobile-payment system may process, send, receive, or store information associated with transactions. In FIG. 1, steps 140 through 156 illustrate a process where user 101 enrolls a payment card in a mobile-payment system, and steps 160 through 172 illustrate a process where the user 101 makes a payment using the mobile-payment system. In particular embodiments, user 101 may use a mobile-payment application 110 running on their mobile device to perform a transaction. In particular embodiments, a mobile device (which may be referred to as a client device, computing device, computing system, client system, client, wireless device, or device) may be a cellular telephone, smartphone, smartwatch, e-book reader, mobile computing device, handheld electronic device, tablet computer, camera, other suitable electronic device, or any suitable combination thereof. Although this disclosure describes and illustrates particular mobile devices used to perform particular transactions, this disclosure contemplates any suitable mobiles devices used to perform any suitable transactions.

In particular embodiments, a mobile device may communicate with a network or another device through one or more wired or wireless communication links. As an example and not by way of limitation, a mobile device may access a network, the Internet, or a server of mobile-payment provider 120 or payment network 130 through one or more wired or wireless communication links. A wired communication link may include a Digital Subscriber Line (DSL) link or a Data Over Cable Service Interface Specification (DOCSIS) link. A wireless communication link may include a Wi-Fi, BLUETOOTH, Worldwide Interoperability for Microwave Access (WiMAX), cellular, or optical link. As another example and not by way of limitation, a mobile device may communicate with a point-of-sale (POS) terminal using near field communication (NFC), radio-frequency identification (RFID), or magnetic secure transmission. In particular embodiments, a POS terminal may be referred to as a contactless payment terminal, payment terminal, or credit-card terminal. In particular embodiments, a user 101 may position their mobile device within a particular threshold distance of a contactless POS terminal to communicate with the terminal using NFC, RFID, or magnetic secure transmission. As an example and not by way of limitation, a mobile device may be positioned within 20 cm, 10 cm, 5 cm, 1 cm, or within any suitable distance of a POS terminal to initiate or perform a transaction through the terminal. Although this disclosure describes particular mobile devices having particular communication capabilities, this disclosure contemplates any suitable mobile devices having any suitable communication capabilities.

In particular embodiments, a transaction may refer to a payment from a user 101 to a merchant for a good or service provided by the merchant. As an example and not by way of limitation, a transaction between user 101 and a merchant may involve or may be facilitated at least in part by mobile-payment provider 120 or payment network 130. In particular embodiments, a transaction may refer to any suitable payment process that involves a mobile device, such as for example card tokenization (e.g., representing a payment card by a token, as described herein), e-currency transactions, or direct mobile billing. In particular embodiments, a merchant may refer to a store, company, vendor, seller, person, or business that provides a good or service to a user 101 (who may be referred to as a buyer, purchaser, customer, or consumer). In particular embodiments, a transaction may be referred to as a purchase, payment, payment transaction, or financial transaction. In particular embodiments, a transaction may include a mobile device interacting with a POS terminal (e.g., to initiate a payment transaction or to receive a transaction record), and at least a portion of a transaction may involve a mobile-payment application 110, a mobile-payment provider 120, or a payment network 130. As an example and not by way of limitation, a mobile device may use mobile-payment application 110 to send a token via a POS terminal to payment network 130, and mobile-payment provider 120 may receive an encrypted transaction record from payment network 130. Although this disclosure describes and illustrates particular transactions that include particular communications between particular portions of a mobile-payment system, this disclosure contemplates any suitable transactions that include any suitable communications between any suitable portions of a mobile-payment system.

In particular embodiments, mobile-payment application 110 may be an application that runs on a mobile device of user 101 and initiates, facilitates, or is involved in at least a portion of a transaction. In particular embodiments, a mobile-payment application 110 may support or perform one or more operations that include displaying a user interface; receiving input from a user 101; interfacing with a POS terminal; sending, receiving, or storing transaction information; or communicating with a mobile-payment provider 120 or a payment network 130. In particular embodiments, mobile-payment application 110 may run in a trusted execution environment (TEE) on a mobile device. A TEE may refer to a secure area of a processor of a mobile device, and the TEE may ensure that code or data loaded in the environment is protected with respect to confidentiality and integrity. As an example and not by way of limitation, a TEE may be an isolated execution environment that provides security features, such as for example isolated execution of the mobile-payment application 110 to ensure the integrity of the mobile-payment application 110 and confidentiality of data associated with the mobile-payment application 110.

In particular embodiments, mobile-payment provider 120 may be a system that facilitates transactions between a mobile-payment application 110 running on a mobile device and a payment network 130. For at least part of a payment-card enrollment process or a payment-transaction process, mobile-payment provider 120 may act as an intermediary between mobile-payment application 110 and payment network 130. A mobile-payment provider 120 (e.g., SAMSUNG PAY), along with an associated mobile-payment application 110, may handle operations such as payment-card enrollment, token management, digital-wallet management, event notifications, or receipt, transmission, or storage of enrollment or transaction-related information. A mobile-payment provider 120 may communicate with a mobile-payment application 110 through a POS terminal, and the mobile-payment provider 120 may communicate with a payment network 130 through one or more wired or wireless communication links.

In particular embodiments, a payment network 130 may be a payment-service provider that facilitates or settles transactions between user 101 and a merchant. As an example and not by way of limitation, payment network 130 may act as a third-party entity to a transaction between user 101 and a merchant. A payment network 130 may issue a payment card to a user 101, and the payment network 130 may send, receive, store, or process information associated with a transaction between the user 101 and a merchant. A payment network 130 may communicate with mobile-payment application 110 or mobile-payment provider 120. A payment network 130 may approve a transaction between user 101 and a merchant, provide a payment to the merchant, and receive a reimbursement from the user 101. In particular embodiments, payment network 130 may be a credit-card company (e.g., VISA, MASTERCARD, or AMERICAN EXPRESS), a direct-debit company (e.g., INTERAC DIRECT PAYMENT), or any other suitable payment-service provider.

In particular embodiments, a payment card may refer to a credit card, debit card, charge card, automated teller machine (ATM) card, stored-value card, or gift card. A payment card may be issued by or affiliated with a payment network 130. A payment card may be electronically linked to one or more accounts (e.g., a bank account or a credit-card account) of a user 101. Although this disclosure describes and illustrates particular payment cards, mobile-payment applications, mobile-payment providers, and payment networks, this disclosure contemplates any suitable payment cards, mobile-payment applications, mobile-payment providers, and payment networks.

In FIG. 1, steps 140 through 156 illustrate a process where user 101 enrolls a payment card in a mobile-payment system. In particular embodiments, user 101 may enroll a payment card with mobile-payment provider 120 or payment network 130, and after enrollment, the user 101 may use a mobile-payment application 110 installed on their mobile device to make payments. At step 140, user 101 submits a payment card for enrollment into a mobile-payment system. In particular embodiments, user 101 may download or install a mobile-payment application 110 on their mobile device, or a mobile-payment application 110 may be pre-installed on their mobile device. As an example and not by way of limitation, the user 101 may download mobile-payment application 110 from a server or website associated with or controlled by mobile-payment provider 120. Once the mobile-payment application 110 is installed and running on the user 101's mobile device, the user 101 may enter, upload, or submit payment-card data to the mobile-payment application 110. As an example and not by way of limitation, a user 101 may submit, via mobile-payment application 110, information or data associated with a payment card, such as for example, a picture of their payment card, a number or identifier of their payment card, information associated with the user 101 (e.g., name, user identifier, e-mail address, billing address, home address, phone number, or security information associated with the user 101), or any other suitable payment-card data.

At step 142, after receiving the payment-card data, mobile-payment application 110 may encrypt the payment-card data. As an example and not by way of limitation, user 101 may enter, upload, or submit information associated with their payment card to mobile-payment application 110, and the mobile-payment application 110 may encrypt some or all of the received payment-card data. At step 144, the mobile-payment application 110 may send the encrypted payment-card data to mobile-payment provider 120. As an example and not by way of limitation, a SAMSUNG PAY mobile-payment application 110 may encrypt and send payment-card data to a server associated with or controlled by the mobile-payment provider SAMSUNG PAY. At step 146, the mobile-payment provider 120 may send the encrypted payment-card data to a payment network 130. As an example and not by way of limitation, if the payment card is affiliated with a particular payment network 130 (e.g., VISA), the mobile-payment provider 120 may send the encrypted payment-card data to a server of the particular payment network 130 for verification or approval of the payment-card enrollment.

At step 148, the payment network 130 may perform an eligibility check and generate a token. The payment network 130 may decrypt the received encrypted payment-card data and perform an eligibility check. The eligibility check may be used to determine whether the submitted payment-card data is valid (e.g., the payment card is associated with an account of the payment network 130 that is active and valid). If payment network 130 determines that the payment-card data is not valid (e.g., the associated account does not exist, is invalid, or is associated with fraudulent activity), then the request to enroll the payment card may be denied. Otherwise, if payment network 130 determines that the payment-card data is valid, then the payment network 130 may approve the enrollment request and generate a token that may be used to represent the payment card in a transaction. In particular embodiments, the token may include a unique identifier that identifies, represents, or corresponds to the payment card submitted by the user 101. As an example and not by way of limitation, the token may include a sequential number, a randomly-generated number, a globally unique identifier (GUID) (which may be referred to as a universally unique identifier (UUID)), a sequence of any suitable alphanumeric or other suitable characters, or any other suitable key or identifier that uniquely identifies, represents or corresponds to the payment card. In particular embodiments, the payment network 130 may encrypt at least a portion of the token.

At step 150, a token generated by payment network 130 may be sent from the payment network 130 to mobile-payment provider 120. As an example and not by way of limitation, the token may be encrypted and then sent by the payment network 130 to the mobile-payment provider 120. At step 152, after receiving the encrypted token from payment network 130, the mobile-payment provider 120 may send the encrypted token to mobile-payment application 110. At step 154, after receiving the encrypted token from mobile-payment provider 120, the mobile-payment application 110 running on user 101's mobile device may decrypt and store the token. At step 156, the mobile-payment application 110 may send a notification or message to the user 101 indicating that the payment card has been successfully enrolled in the mobile-payment system. At this point, the user 101's payment card has been enrolled, and the user 101 may use the token stored in their mobile device to make a purchase. A payment performed by the mobile-payment application 110 that uses the token may correspond to a payment made with the payment card associated with the token.

In FIG. 1, steps 160 through 172 illustrate a process where user 101 makes a payment using their mobile device and the mobile-payment system. In particular embodiments, a transaction as illustrated by steps 160 through 172 may include a transmission of a token from a mobile device to payment network 130, where the token represents a payment card of user 101. As an example and not by way of limitation, through a mobile-payment application 110 running on their mobile device, user 101 can make a purchase from a merchant using the token stored on the mobile device. The token, which may be generated through an enrollment process as described above, represents a particular payment card. In particular embodiments, after successful completion of a purchase, a transaction record that includes information related to the purchase may be received by the mobile device.

At step 160, user 101 interacts with mobile-payment application 110 to initiate a payment transaction. As an example and not by way of limitation, user 101 may interact with a user interface displayed on their mobile device and provided by mobile-payment application 110 to indicate that they wish to pay for something using a particular payment card.

At step 162, mobile-payment application 110 sends a token (e.g., via a POS terminal) to payment network 130. As an example and not by way of limitation, the mobile-payment application 110 may identify a token associated with a payment card indicated by the user 101, and the mobile-payment application 110 may interact with a POS terminal (e.g., using a NFC process) to send the token to payment network 130. In particular embodiments, the token sent to payment network 130 may be encrypted. In particular embodiments, mobile-payment application 110 may send a token directly to payment network 130, or mobile-payment application 110 may send a token to payment network 130 through mobile-payment provider 120.

At step 164, payment network 130 receives the token and processes the payment transaction. As an example and not by way of limitation, payment network 130 may decrypt the received token, and payment network 130 may confirm that the token is valid (e.g., that the token corresponds to a valid payment card that has been enrolled for mobile payments). Once the token is confirmed to be valid, payment network 130 may process the payment transaction (e.g., the payment network 130 may settle the transaction by initiating a payment to the merchant and debiting user 101's account). In particular embodiments, the payment network 130 may generate a transaction record that corresponds to the transaction and includes information associated with the transaction. In particular embodiments, a transaction record may be a record generated by payment network 130 after a transaction has been settled. As an example and not by way of limitation, a transaction record may include one or more of the following: an identifier of a transaction; a name or identifier of a user 101 involved in the transaction; a date or time (e.g., a timestamp) of the transaction; a location of a mobile device (e.g., the device that initiated the transaction) when the transaction was initiated or completed; an amount of the transaction (e.g., an amount of money in United States dollars, Canadian dollars, euros, or any other suitable currency); a description of a good or service received in the transaction; a name, identifier, website, or location of a merchant that provided the received good or service; a name or identifier of mobile-payment provider 120; a name or identifier of the payment network 130 involved in the transaction; or information associated with a payment card associated with the transaction (e.g., a cardholder name, a card number, or the last four digits of the card number). As another example and not by way of limitation, a transaction record corresponding to a purchase of a bicycle may include the following information: user: John Smith; date: October 2015; time: 10:27:11; amount: $1,510; description: bicycle, TREK, model 720, size 61; merchant: Velo Bike Shop. As another example and not by way of limitation, a transaction record corresponding to a stay at a hotel may include the following information: user: Jane Smith; date: 8 Jun. 2016; amount: $411; description: 2-night stay; merchant: Overlook Hotel. In particular embodiments, a location of a mobile device or a merchant may refer to a geographic location associated with the mobile device or merchant. As an example and not by way of limitation, a mobile-device location or a merchant location may include an address, city, state, province, country, region, place, latitude-longitude pair, or any other suitable geographic-location identifier that specifies where a mobile device or merchant is located. In particular embodiments, payment network 130 may store a transaction record, and the transaction record stored by the payment network 130 may be referred to as a payment-network transaction record. Although this disclosure describes particular transaction records that include particular information, this disclosure contemplates any suitable transaction records that include any suitable information.

At step 166, payment network 130 sends an encrypted transaction record to mobile-payment provider 120. As an example and not by way of limitation, payment network 130 may encrypt all or part of the transaction-record information and send the encrypted information to mobile-payment provider 120. In particular embodiments, mobile-payment provider 120 may decrypt the encrypted transaction record received from payment network 130, and mobile-payment provider 120 may store all or part of the received transaction-record information. A transaction record maintained or stored by mobile-payment provider 120 may be referred to as a mobile-payment-provider transaction record.

At step 168, mobile-payment provider 120 sends the encrypted transaction record to mobile-payment application 110. As an example and not by way of limitation, after receiving a transaction record from payment network 130, mobile-payment provider 120 may send the transaction record to mobile-payment application 110 running on the mobile device of user 101 who initiated the transaction.

At step 170, mobile-payment application 110 may decrypt the encrypted transaction record received from mobile-payment provider 120. In particular embodiments, mobile-payment application 110 may store a transaction record on the mobile device for later use or retrieval. The transaction record stored by mobile-payment application 110 may be referred to as a client-side transaction record.

At step 172, mobile-payment application 110 displays information from the client-side transaction record to user 101. As an example and not by way of limitation, mobile-payment application 110 may display a message to the user 101 indicating that a transaction was successfully processed. Additionally, mobile-payment application 110 may display all or part of a transaction record, such as for example, a date or time of a transaction, an amount of the transaction, a description of a good or service received, or a name of the merchant.

Particular embodiments may repeat one or more steps of the interaction diagram of FIG. 1, where appropriate. Although this disclosure describes and illustrates particular steps of the interaction diagram of FIG. 1 as occurring in a particular order, this disclosure contemplates any suitable steps of the interaction diagram of FIG. 1 occurring in any suitable order. Moreover, although this disclosure describes and illustrates an example interaction diagram associated with enrolling a payment card in a mobile-payment system including the particular steps of the interaction diagram of FIG. 1, this disclosure contemplates any suitable interaction diagram associated with enrolling a payment card in a mobile-payment system including any suitable steps, which may include all, some, or none of the steps of the interaction diagram of FIG. 1, where appropriate. Additionally, although this disclosure describes and illustrates an example interaction diagram associated with making a payment using a mobile-payment system including the particular steps of the interaction diagram of FIG. 1, this disclosure contemplates any suitable interaction diagram associated with making a payment using a mobile-payment system including any suitable steps, which may include all, some, or none of the steps of the interaction diagram of FIG. 1, where appropriate. Furthermore, although this disclosure describes and illustrates particular components, devices, or systems carrying out particular steps of the interaction diagram of FIG. 1, this disclosure contemplates any suitable combination of any suitable components, devices, or systems carrying out any suitable steps of the interaction diagram of FIG. 1.

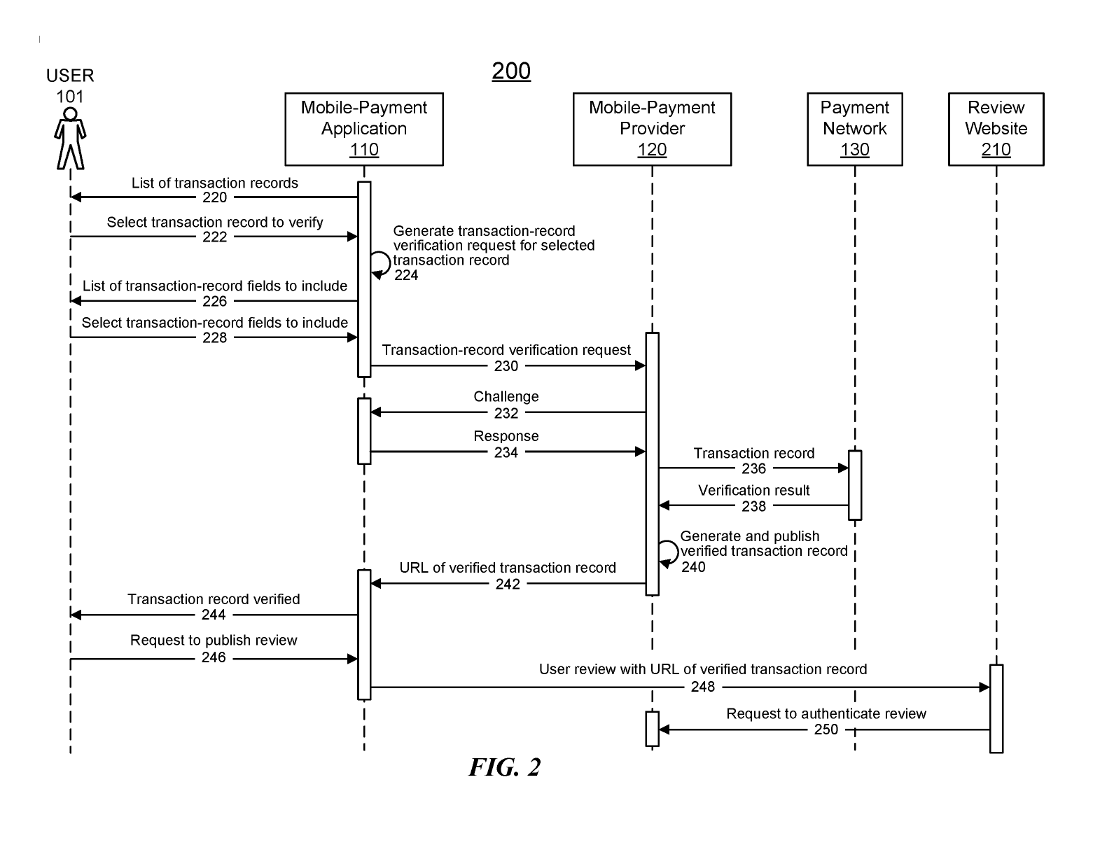

FIG. 2 illustrates an example interaction diagram 200 associated with a transaction-record verification process for a mobile-payment system. In particular embodiments, a transaction-record verification process may allow a user 101 to establish the authenticity of a transaction record for a transaction performed through a mobile-payment system. As an example and not by way of limitation, user 101 may publish (e.g., on a review website 210) a review of a product or service provided by a merchant. The review may include an indication that the user 101 performed a transaction with the merchant, and the review may further indicate that the transaction has been verified (e.g., through a transaction-record verification process as described herein).

At step 220, mobile-payment application 110 presents a list of transaction records. As an example and not by way of limitation, mobile-payment application 110 may display a list of transaction records that correspond to one or more previously completed mobile-payment transactions performed by user 101 with their mobile device. The list of transaction records may be presented on a display of user 101's mobile device, and each transaction may correspond to a previously completed purchase that was initiated by the user 101 through their mobile device. In particular embodiments, mobile-payment application 110 may store or maintain client-side transaction records corresponding to previously completed transactions. A list of transaction records presented to a user 101 may correspond to one or more of the client-side transaction records stored or maintained by mobile-payment application 110. Each entry in a list of transaction records may include information from an associated client-side transaction record (e.g., a date or time of a transaction, an amount of the transaction, a description of a good or service received, or a name of a merchant). In particular embodiments, each client-side transaction record stored or maintained by mobile-payment application 110 may include one or more of the following: an identifier of a transaction; a name or identifier of user 101; a date or time (e.g., a timestamp) of a transaction; a location of the mobile device when a transaction was initiated or completed; an amount of a transaction; a description of a good or service received in a transaction; a name, identifier, website, or location of a merchant that provided a received good or service; a name or identifier of mobile-payment provider 120; a name or identifier of payment network 130 that was involved in a transaction; or information associated with a payment card associated with a transaction.

At step 222, mobile-payment application 110 receives a selection of a transaction record to verify. In particular embodiments, mobile-payment application 110 may receive from user 101 a request to verify one or more transaction records, where the transaction records to be verified are selected from a list of displayed transaction records. In particular embodiments, in addition to receiving a selection of one or more transaction records to verify, mobile-payment application 110 may also receive additional metadata associated with the selected transactions. In particular embodiments, metadata associated with a transaction may refer to a document (e.g., user content, such as for example, a review of a merchant written by user 101), numerical value (e.g., a star rating on a scale of one to five stars), user name or identifier (e.g., a user's name or their user name on a third-party website), file, multimedia file (e.g., image, video, or audio file), or any suitable combination thereof. As an example and not by way of limitation, user 101 may select a particular transaction for verification, and the user 101 may also include a review associated with the selected transaction. After successful verification of the selected transaction, the review may be published (e.g., to a third-party website).

At step 224, mobile-payment application 110 generates a transaction-record verification request for one or more selected transaction records. As an example and not by way of limitation, after receiving from user 101 a selection of a particular transaction for verification, mobile-payment application 110 may generate a transaction-record verification request for the selected transaction. The transaction-record verification request may include information associated with or that identifies the particular transaction. As an example and not by way of limitation, a transaction-record verification request may include information from a corresponding client-side transaction record (e.g., an identifier of a transaction, a date or time of the transaction, an amount of the transaction, a description of a good or service received in the transaction, or a name of a merchant that provided the good or service).

At step 226, mobile-payment application 110 may present a list of transaction-record fields to include. As an example and not by way of limitation, in response to receiving a selection of a particular transaction for verification, mobile-payment application 110 may present to user 101 a list of transaction-record fields to include in the verification request to be sent to mobile-payment provider 120. In particular embodiments, the transaction-record fields included in a verification request may include one or more of the following: an identifier of a transaction; a name or identifier of a user 101 involved in the transaction; a date or time of the transaction; a location of the mobile device when the transaction was initiated or completed; an amount of the transaction; a description of a good or service received in the transaction; a name, identifier, website, or location of a merchant that provided the received good or service; a name or identifier of mobile-payment provider 120; a name or identifier of the payment network 130 involved in the transaction; or information associated with a payment card associated with the transaction. Additionally, mobile-payment application 110 may allow user 101 to attach additional metadata (e.g., a review, an image, or a video) to be included with the transaction-record verification request. In particular embodiments, a name or identifier of user 101 may include user 101's name, user 101's first or last name, an alias or nickname of user 101, or user 101's identifier on a third-party website (e.g., a user name on a review website 210 or a social-media website).

At step 228, mobile-payment application 110 may receive a selection of one or more transaction-record fields to include. As an example and not by way of limitation, user 101 may specify to mobile-payment application 110 one or more transaction-record fields to include in a verification request to be sent to mobile-payment provider 120. As another example and not by way of limitation, user 101 may specify that the following fields should be included in a verification request: user identifier: jane-the-traveler; date: June 2016; description: 2-night stay; merchant: Overlook Hotel. In particular embodiments, providing an opportunity for user 101 to choose which information to include in a transaction-record verification request may allow the user 101 to maintain control over their privacy. As an example and not by way of limitation, a user 101 may be able to specify which information may be revealed to or displayed on a third-party website. As another example and not by way of limitation, instead of revealing their full name (e.g., “Jane Smith”), a user 101 may choose to reveal their user name or identifier (e.g., “jane-the-traveler”). As another example and not by way of limitation, rather than revealing a specific date when a transaction took place (e.g., “8 Jun. 2016”), a user 101 may choose to reveal a general timeframe for the transaction (e.g., “June 2016” or “2016”).

In particular embodiments, step 224 of FIG. 2 may occur before or after steps 226 or 228. As an example and not by way of limitation, a transaction-record verification request may be generated after step 222 (e.g., after mobile-payment application 110 receives a selection of a transaction record to verify) and before steps 226 and 228. As another example and not by way of limitation, a transaction-record verification request may be generated after step 228 (e.g., after mobile-payment application 110 receives a selection of a transaction record to verify as well as a selection of associated transaction-record fields to include in the verification request).

At step 230, mobile-payment provider 120 may receive a transaction verification request. In particular embodiments, mobile-payment provider 120 may receive, from a mobile device, a request to verify a client-side transaction record identifying a transaction involving a user 101 of the mobile device. The transaction-record verification request may be sent by the mobile-payment application 110 running on a mobile device of user 101. A transaction-record verification request may include a request to verify that information in a client-side transaction record is authentic or accurate. In particular embodiments, a transaction-record verification request may include all or part of the information in an associated client-side transaction record. As an example and not by way of limitation, a request to verify a client-side transaction record may include one or more of the following: an identifier of a transaction; a name or identifier of a user involved in the transaction; a date or time of the transaction; a location of the mobile device when the transaction was initiated or completed; an amount of the transaction; a description of a good or service received in the transaction; a name, identifier, website, or location of a merchant that provided the received good or service; a name or identifier of mobile-payment provider 120; a name or identifier of the payment network 130 involved in the transaction; or information associated with a payment card associated with the transaction. Additionally, a transaction-record verification request may include metadata selected or generated by user 101, such as for example, a rating or review of the received good or service or a multimedia file associated with the transaction.

At step 232, in response to receiving a transaction-record verification request from mobile-payment application 110, mobile-payment provider 120 may send a challenge to mobile-payment application 110. At step 234, in response to the challenge, mobile-payment provider 120 may receive a response from mobile-payment application 110. In particular embodiments, mobile-payment provider 120 may verify that a mobile-payment application 110 is valid (e.g., verify that the application is trusted or has not been tampered with). In particular embodiments, a challenge-response authentication process (e.g., as illustrated by steps 232 and 234 in FIG. 2) may be used to verify the integrity of a mobile-payment application 110 that submitted a transaction-record verification request. A challenge-response process may include mobile-payment provider 120 presenting a question (or, challenge) to mobile-payment application 110, and mobile-payment application 110 must provide a valid answer (or, response) in order to be authenticated. If a valid or correct response is received from mobile-payment application 110, then mobile-payment provider 120 may determine that the mobile-payment application 110 has not been altered or tampered with. In particular embodiments, a challenge-response process may be used to verify the authenticity of a client-side transaction record associated with a transaction-record verification request. As an example and not by way of limitation, a challenge-response process may verify that a mobile-payment application 110 or a transaction record is trusted or authentic (e.g., the mobile-payment application 110 or transaction record has not been tampered with, corrupted, or compromised). In particular embodiments, a challenge-response process may prevent a malicious party from altering transaction records or forging or creating fake transaction records. In particular embodiments, all or part of a challenge or response may be encrypted.

In particular embodiments, verifying that a mobile-payment application 110 or a transaction record is valid may include performing a remote attestation of a mobile device. As an example and not by way of limitation, the challenge-response process illustrated by steps 232 and 234 in FIG. 2 may include a remote attestation of the mobile device on which mobile-payment application 110 is installed or running. A remote attestation may allow mobile-payment provider 120 to determine if any unauthorized changes have been made to the mobile-payment application 110. In response to a remote-attestation challenge of step 232, a mobile device may generate a certificate that shows that the software of the mobile-payment application 110 has not been altered or tampered with, and in step 234 the certificate is sent to mobile-payment provider 120 as a remote-attestation response. In particular embodiments, the validity of a mobile-payment application 110 may be ensured, at least in part, by the TEE in which mobile-payment application 110 runs.

In particular embodiments, in response to receiving a transaction-record verification request from mobile-payment application 110, mobile-payment provider 120 may determine whether a client-side transaction record associated with the request is valid. As an example and not by way of limitation, rather than forwarding a transaction-record verification request to payment network 130 for verification, a verification process may be performed by mobile-payment provider 120. In particular embodiments, verifying that a client-side transaction record is valid may be based at least in part on verifying that a mobile-payment application 110 is valid (e.g., by performing a remote attestation as described above). As an example and not by way of limitation, the authenticity of a transaction record may be inferred based on a successful verification of the integrity of the mobile-payment application 110 that submitted the transaction-record verification request. If mobile-payment provider 120 determines that mobile-payment application 110 is valid (e.g., the application has not been altered or tampered with), then mobile-payment provider 120 may determine that information provided by mobile-payment application 110 is similarly valid. In particular embodiments, a mobile-payment application 110 being valid may refer to a mobile-payment application 110 that is trusted or authentic or that has not been altered, forged, corrupted, or tampered with (e.g., by a malicious party). In particular embodiments, a transaction record being valid may refer to a transaction record that is trusted or authentic or that has not been altered, forged, corrupted, or tampered with (e.g., by a malicious party).

In particular embodiments, verifying that a client-side transaction record is valid may be based at least in part on comparing information in a transaction-record verification request with corresponding information collected by or maintained within mobile-payment provider 120. As an example and not by way of limitation, verifying that a client-side transaction record is valid may be based at least in part on determining that all or part of the client-side transaction record matches all or part of corresponding information stored with mobile-payment provider 120. The corresponding information stored with mobile-payment provider 120 may include a mobile-payment-provider transaction record which was previously received from payment network 130 after settlement of a corresponding transaction. If the information in a transaction-record verification request matches corresponding information in a mobile-payment-provider transaction record, then mobile-payment provider 120 may determine that the corresponding client-side transaction record is valid. As another example and not by way of limitation, verifying that a client-side transaction record is valid may be based at least in part on comparing information in a transaction-record verification request with non-encrypted transaction metadata or information that was previously transmitted from payment network 130 to mobile-payment provider 120 after settlement of a corresponding transaction.

At step 236, mobile-payment provider 120 may send transaction-record information to payment network 130 for verification. At step 238, mobile-payment provider 120 may receive a verification result from payment network 130. In particular embodiments, in response to receiving a transaction-record verification request from mobile-payment application 110, mobile-payment provider 120 may send the transaction-record verification request to payment network 130. As an example and not by way of limitation, a verification request sent to payment network 130 may include all or part of the information in the transaction-record verification request received from mobile-payment application 110. As another example and not by way of limitation, a verification request sent to payment network 130 may include all of part of a client-side transaction record associated with the transaction-record verification request. In particular embodiments, payment network 130 may compare information in a received transaction-record verification request with comparable information maintained or stored by payment network 130. As an example and not by way of limitation, after payment network 130 processes a transaction (as illustrated by step 164 in FIG. 1), payment network 130 may store a payment-network transaction record or other information associated with the transaction. If information in a stored payment-network transaction record matches comparable information in a received transaction-record verification request, then payment network 130 may determine that the corresponding transaction record is valid. At step 238, in response to determining that the transaction record is valid, payment network 130 may send a verification result to mobile-payment provider 120 indicating that the transaction record is valid.

In particular embodiments, mobile-payment provider 120 may determine whether a transaction identified in a client-side transaction record is valid. In particular embodiments, determining whether a transaction identified in a client-side transaction record is valid may be based at least in part on verifying that the transaction identified in the client-side transaction record is also identified in a payment-network transaction record that is separate from the client-side transaction record. As an example and not by way of limitation, verifying that a transaction identified in a client-side transaction record is also identified in a payment-network transaction record may include comparing information in a request to verify a client-side transaction record with other information (e.g., a mobile-payment-provider transaction record) collected or maintained by mobile-payment provider 120. If information in a transaction-record verification request matches corresponding information maintained by mobile-payment provider 120, then mobile-payment provider 120 may determine that the transaction identified in the client-side transaction record is valid. As another example and not by way of limitation, verifying that a transaction identified in a client-side transaction record is also identified in a payment-network transaction record may include: (1) sending information associated with the client-side transaction record to a payment network 130 associated with the transaction (e.g., as illustrated by step 236 in FIG. 2), and (2) receiving from the payment network 130 an indication that the information associated with the client-side transaction record matches related information in the payment-network transaction record (e.g., as illustrated by step 238 in FIG. 2). In particular embodiments, verifying that a transaction identified in a client-side transaction record is also identified in a payment-network transaction record may be based at least in part on verifying that mobile-payment application 110 is valid. If a mobile-payment application 110 is determined to be valid, then mobile-payment provider 120 may determine that transaction information received from the mobile-payment application 110 is similarly valid.

At step 240, mobile-payment provider 120 may generate and publish a verified transaction record. In particular embodiments, in response to verifying that a transaction is valid (e.g., by verifying that the transaction identified in a client-side transaction record is also identified in a payment-network transaction record), mobile-payment provider 120 may generate or publish a verification of an associated transaction record (which may be referred to as a transaction-record verification). In particular embodiments, publishing a verification of a transaction record may include publishing to a website an indication that an associated client-side transaction record is valid. Publishing a verification of a transaction record may also include publishing one or more transaction-record fields from the transaction record (e.g., one or more fields selected by user 101 in step 228 of FIG. 2) or other metadata collected by mobile-payment provider 120 (e.g., a map showing a location of a merchant or a link to a website of the merchant). As an example and not by way of limitation, a transaction-record verification may include a name, identifier, web site, or location of a merchant involved in a transaction. As another example and not by way of limitation, a published transaction-record verification may include an indication that a particular transaction is valid along with the following information associated with the transaction: user identifier: jane-the-traveler; date: June 2016; description: 2-night stay; merchant: Overlook Hotel. This transaction-record verification indicates that a user with the identifier “jane-the-traveler” stayed for two nights at the Overlook Hotel in June 2016. As another example and not by way of limitation, a transaction-record verification may include additional metadata associated with a transaction (e.g., user content, a review of a merchant written by user 101, or an image or video that shows the merchant or a good or service provided by the merchant).

In particular embodiments, publishing a verification of a transaction record may include publishing a transaction-record verification to a website of mobile-payment provider 120. As an example and not by way of limitation, a transaction-record verification may be published to a trusted website that is operated by, associated with, or controlled by mobile-payment provider 120. In particular embodiments, publishing a transaction-record verification may include making a transaction-record verification available at a web location having a particular uniform resource identifier (URI). As an example and not by way of limitation, the URI may be a uniform resource locator (URL) or web address of a website of mobile-payment provider 120. In particular embodiments, performing a verification of a transaction and publishing an associated transaction-record verification to a trusted website may provide a third party (e.g., a review website 210) confidence that the transaction is valid. In particular embodiments, mobile-payment provider 120 may publish user content (e.g., a review of a merchant written by user 101) along with an embedded link to a published transaction-record verification.

In particular embodiments, mobile-payment provider 120 may send information associated with a verified transaction to a third-party entity. As an example and not by way of limitation, in response to verifying that a transaction is valid, mobile-payment provider 120 may provide to a third-party entity an associated transaction-record verification or metadata associated with the transaction. As another example and not by way of limitation, once a transaction is verified, mobile-payment provider 120 may send to one or more third-party entities information associated with the verified transaction along with a review written by user 101. As another example and not by way of limitation, mobile-payment provider 120 may send to one or more third-party entities a link to a URI where a transaction-record verification is available. The third-party entities may include a review website 210 (e.g., YELP or TRIPADVISOR) or a social-media website. In particular embodiments, mobile-payment provider 120 may facilitate the distribution of a review to multiple review or social-media websites in an efficient manner. As an example and not by way of limitation, one a transaction is verified, mobile-payment provider 120 may automatically distribute a transaction-record verification to multiple review websites 210. The review websites 210 may be determined automatically or may be specified by user 101 (e.g., the user 101 may have previously indicated the review websites 210 for distribution).

At step 242, mobile-payment provider 120 sends a URL of a verified transaction record to mobile-payment application 110. In particular embodiments, mobile-payment provider 120 may send, to a mobile device that originated a transaction-record verification request, a URI corresponding to a web location that includes a published verification of the transaction record. In particular embodiments, a URI received by mobile-payment application 110 may be shared with a third-party entity (e.g., review website 210) to establish the authenticity of an associated transaction record.

At step 244, mobile-payment application 110 presents an indication that the selected transaction record has been verified. As an example and not by way of limitation, mobile-payment application 110 may display a notification or message to user 101 indicating that the selected transaction record has been successfully verified as being valid. Additionally, mobile-payment application 110 may present a list of actions that user 101 may perform, such as for example, submitting a review (or other user-generated content) to a review website 210. In particular embodiments, user-generated content or other information submitted to a third-party entity may include an embedded link to a published transaction-record verification. In particular embodiments, user content regarding a transaction may include a review of a product or service associated with the transaction, where the review is to be displayed on a website of a third-party entity (e.g., review website 210).

At step 246, mobile-payment application 110 receives a request to publish a review. In particular embodiments, mobile-payment application 110 may receive a request from user 101 to publish a review (or other user-generated content related to a transaction) to one or more third-party entities (e.g., review website 210). As an example and not by way of limitation, a user 101 may wish to publish a review of a good or service provided by a merchant.

At step 248, in response to receiving a request to publish a review, mobile-payment application 110 sends to review website 210 a user review along with a URL of a verified transaction record. The URL may correspond to a web location of a website controlled by mobile-payment provider 120. In particular embodiments, in response to receiving a request to publish a review, mobile-payment application 110 may send to one or more review websites 210 the review along with a URI of a verified transaction record or an indication that an associated transaction has been verified as being valid.

At step 250, mobile-payment provider 120 may receive a request from review website 210 to authenticate a review. In particular embodiments, prior to publishing a review, a third-party entity (e.g., review website 210) may access a published transaction-record verification to verify that the transaction associated with the review is valid. In particular embodiments, mobile-payment provider 120 may receive a request from a third-party entity to access a published transaction-record verification from a particular URI. In response to the request, mobile-payment provider 120 may provide the published transaction-record verification to the third-party entity. In particular embodiments, a request to access a published transaction-record verification may be generated in response to a request from user 101 to generate user content regarding an associated transaction. As an example and not by way of limitation, a user 101 may seek to publish a review to review website 210, and in response to the user's request, review website 210 may send a request to mobile-payment provider 120 to access an associated transaction-record verification. In particular embodiments, a published review on review website 210 may include an embedded link to a published transaction-record verification (e.g., a URI corresponding to a web address of mobile-payment provider 120 from which the published transaction-record verification may be accessed). In particular embodiments, a published review may include an indication that a transaction associated with the review has been verified as being valid. As an example and not by way of limitation, a published review may be accompanied by text (e.g., “Validated by SAMSUNG PAY”) or an image indicating that the associated transaction has been verified as being valid.

Particular embodiments may repeat one or more steps of the interaction diagram of FIG. 2, where appropriate. Although this disclosure describes and illustrates particular steps of the interaction diagram of FIG. 2 as occurring in a particular order, this disclosure contemplates any suitable steps of the interaction diagram of FIG. 2 occurring in any suitable order. Moreover, although this disclosure describes and illustrates an example interaction diagram associated with a transaction-record verification process including the particular steps of the interaction diagram of FIG. 2, this disclosure contemplates any suitable interaction diagram associated with a transaction-record verification process including any suitable steps, which may include all, some, or none of the steps of the interaction diagram of FIG. 2, where appropriate. Furthermore, although this disclosure describes and illustrates particular components, devices, or systems carrying out particular steps of the interaction diagram of FIG. 2, this disclosure contemplates any suitable combination of any suitable components, devices, or systems carrying out any suitable steps of the interaction diagram of FIG. 2.

In particular embodiments, one or more methods as described herein may allow a user 101 of a mobile-payment provider 120 to efficiently publish a verification of or details related to a transaction so that the details can be confirmed as valid by a third-party entity. Additionally, one or more methods as described herein may allow a user 101 to establish the authenticity of a transaction record for a transaction performed with mobile-payment provider 120. Since at least part of a transaction may be performed through mobile-payment provider 120, the mobile payment provider 120 may be able to efficiently perform a transaction-record verification process without user 101 having to manually provide details of the transaction (e.g., a scanned receipt from a merchant). Additionally, after verification, user 101 or mobile-payment provider 120 may be able to publish user-generated content or a verified transaction record to one or more third-party entities. In particular embodiments, a transaction-record verification process, as described herein, may be performed with user 101 being able to control the amount, if any, of their personal information that may be disclosed. As an example and not by way of limitation, user 101 may maintain control of their privacy by selecting which transaction records may be disclosed and what information may or may not be included in a published transaction-record verification.

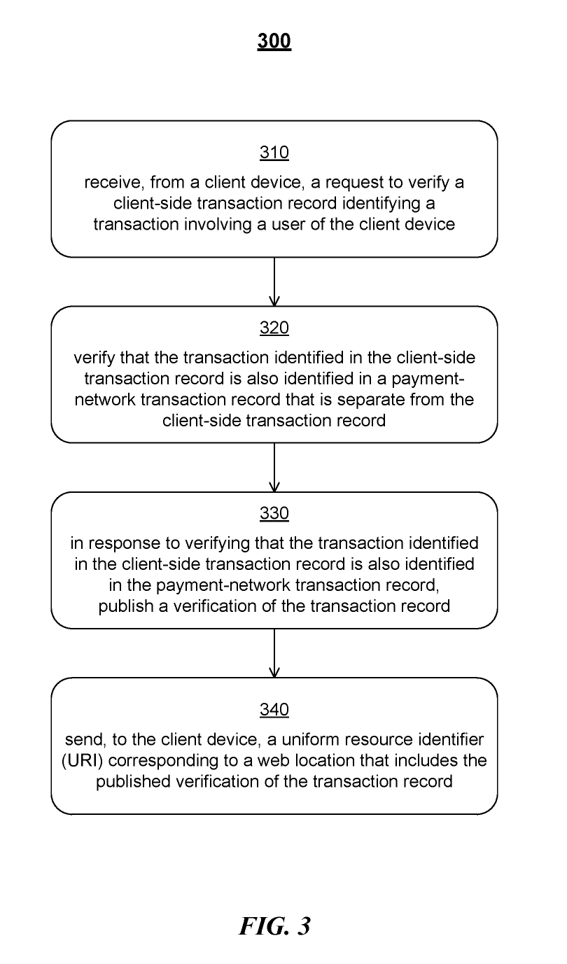

FIG. 3 illustrates an example method 300 for verifying a transaction record. The method may begin at step 310, where mobile-payment provider 120 may receive, from a client device, a request to verify a client-side transaction record identifying a transaction involving a user 101 of the client device. At step 320, mobile-payment provider 120 may verify that the transaction identified in the client-side transaction record is also identified in a payment-network transaction record that is separate from the client-side transaction record. As an example and not by way of limitation, mobile-payment provider 120 may send information associated with the transaction to payment network 130 for verification. As another example and not by way of limitation, mobile-payment provider 120 may perform a verification process based on a remote attestation of the client device or based on comparing information in the request received from the client device with other information stored or maintained by mobile-payment provider 120. At step 330, in response to verifying that the transaction identified in the client-side transaction record is also identified in the payment-network transaction record, mobile-payment provider 120 may publish a verification of the transaction record. As an example and not by way of limitation, mobile-payment provider 120 may publish a transaction-record verification to a website of mobile-payment provider 120, and the published transaction-record verification may be accessible to one or more third-party entities. Additionally, mobile-payment provider 120 may publish a review or other user-generated content to a website of mobile-payment provider 120. At step 340, mobile-payment provider 120 may send, to the client device, a uniform resource identifier (URI) corresponding to a web location that includes the published verification of the transaction record. As an example and not by way of limitation, a URI that includes a published transaction-record verification may be sent to a third-party entity to indicate that the associated transaction record is valid. Particular embodiments may repeat one or more steps of the method of FIG. 3, where appropriate. Although this disclosure describes and illustrates particular steps of the method of FIG. 3 as occurring in a particular order, this disclosure contemplates any suitable steps of the method of FIG. 3 occurring in any suitable order. Moreover, although this disclosure describes and illustrates an example method for verifying a transaction record including the particular steps of the method of FIG. 3, this disclosure contemplates any suitable method for verifying a transaction record including any suitable steps, which may include all, some, or none of the steps of the method of FIG. 3, where appropriate. Furthermore, although this disclosure describes and illustrates particular components, devices, or systems carrying out particular steps of the method of FIG. 3, this disclosure contemplates any suitable combination of any suitable components, devices, or systems carrying out any suitable steps of the method of FIG. 3.

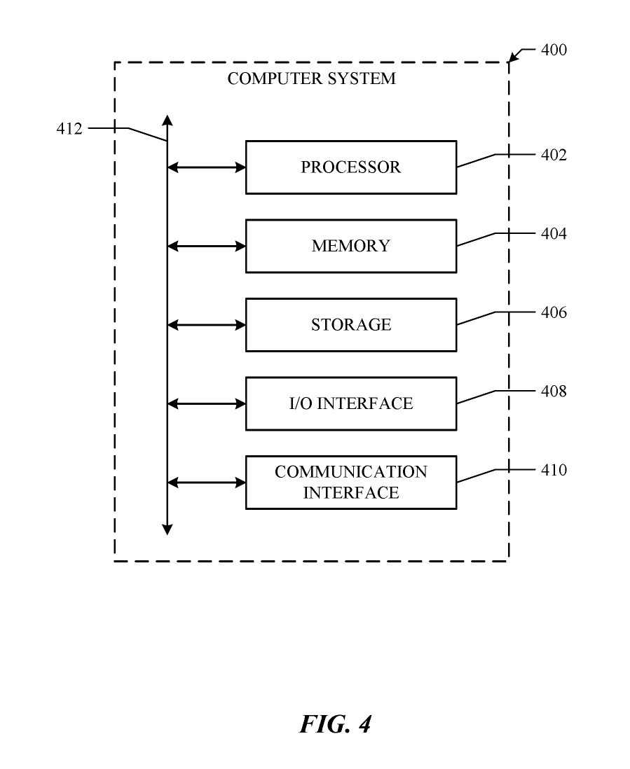

FIG. 4 illustrates an example computer system 400. In particular embodiments, one or more computer systems 400 perform one or more steps of one or more methods described or illustrated herein. In particular embodiments, one or more computer systems 400 provide functionality described or illustrated herein. In particular embodiments, software running on one or more computer systems 400 performs one or more steps of one or more methods described or illustrated herein or provides functionality described or illustrated herein. Particular embodiments include one or more portions of one or more computer systems 400. Herein, reference to a computer system may encompass a computing device, and vice versa, where appropriate. Moreover, reference to a computer system may encompass one or more computer systems, where appropriate.

This disclosure contemplates any suitable number of computer systems 400. This disclosure contemplates computer system 400 taking any suitable physical form. As example and not by way of limitation, computer system 400 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, or a combination of two or more of these. Where appropriate, computer system 400 may include one or more computer systems 400; be unitary or distributed; span multiple locations; span multiple machines; span multiple data centers; or reside in a cloud, which may include one or more cloud components in one or more networks. Where appropriate, one or more computer systems 400 may perform without substantial spatial or temporal limitation one or more steps of one or more methods described or illustrated herein. As an example and not by way of limitation, one or more computer systems 400 may perform in real time or in batch mode one or more steps of one or more methods described or illustrated herein. One or more computer systems 400 may perform at different times or at different locations one or more steps of one or more methods described or illustrated herein, where appropriate.

In particular embodiments, computer system 400 includes a processor 402, memory 404, storage 406, an input/output (I/O) interface 408, a communication interface 410, and a bus 412. Although this disclosure describes and illustrates a particular computer system having a particular number of particular components in a particular arrangement, this disclosure contemplates any suitable computer system having any suitable number of any suitable components in any suitable arrangement.

In particular embodiments, processor 402 includes hardware for executing instructions, such as those making up a computer program. As an example and not by way of limitation, to execute instructions, processor 402 may retrieve (or fetch) the instructions from an internal register, an internal cache, memory 404, or storage 406; decode and execute them; and then write one or more results to an internal register, an internal cache, memory 404, or storage 406. In particular embodiments, processor 402 may include one or more internal caches for data, instructions, or addresses. This disclosure contemplates processor 402 including any suitable number of any suitable internal caches, where appropriate. As an example and not by way of limitation, processor 402 may include one or more instruction caches, one or more data caches, and one or more translation lookaside buffers (TLBs). Instructions in the instruction caches may be copies of instructions in memory 404 or storage 406, and the instruction caches may speed up retrieval of those instructions by processor 402. Data in the data caches may be copies of data in memory 404 or storage 406 for instructions executing at processor 402 to operate on; the results of previous instructions executed at processor 402 for access by subsequent instructions executing at processor 402 or for writing to memory 404 or storage 406; or other suitable data. The data caches may speed up read or write operations by processor 402. The TLBs may speed up virtual-address translation for processor 402. In particular embodiments, processor 402 may include one or more internal registers for data, instructions, or addresses. This disclosure contemplates processor 402 including any suitable number of any suitable internal registers, where appropriate. Where appropriate, processor 402 may include one or more arithmetic logic units (ALUs); be a multi-core processor; or include one or more processors 402. Although this disclosure describes and illustrates a particular processor, this disclosure contemplates any suitable processor.

In particular embodiments, memory 404 includes main memory for storing instructions for processor 402 to execute or data for processor 402 to operate on. As an example and not by way of limitation, computer system 400 may load instructions from storage 406 or another source (such as, for example, another computer system 400) to memory 404. Processor 402 may then load the instructions from memory 404 to an internal register or internal cache. To execute the instructions, processor 402 may retrieve the instructions from the internal register or internal cache and decode them. During or after execution of the instructions, processor 402 may write one or more results (which may be intermediate or final results) to the internal register or internal cache. Processor 402 may then write one or more of those results to memory 404. In particular embodiments, processor 402 executes only instructions in one or more internal registers or internal caches or in memory 404 (as opposed to storage 406 or elsewhere) and operates only on data in one or more internal registers or internal caches or in memory 404 (as opposed to storage 406 or elsewhere). One or more memory buses (which may each include an address bus and a data bus) may couple processor 402 to memory 404. Bus 412 may include one or more memory buses, as described below. In particular embodiments, one or more memory management units (MMUs) reside between processor 402 and memory 404 and facilitate accesses to memory 404 requested by processor 402. In particular embodiments, memory 404 includes random access memory (RAM). This RAM may be volatile memory, where appropriate, and this RAM may be dynamic RAM (DRAM) or static RAM (SRAM), where appropriate. Moreover, where appropriate, this RAM may be single-ported or multi-ported RAM. This disclosure contemplates any suitable RAM. Memory 404 may include one or more memories 404, where appropriate. Although this disclosure describes and illustrates particular memory, this disclosure contemplates any suitable memory.

In particular embodiments, storage 406 includes mass storage for data or instructions. As an example and not by way of limitation, storage 406 may include a hard disk drive (HDD), a floppy disk drive, flash memory, an optical disc, a magneto-optical disc, magnetic tape, or a Universal Serial Bus (USB) drive or a combination of two or more of these. Storage 406 may include removable or non-removable (or fixed) media, where appropriate. Storage 406 may be internal or external to computer system 400, where appropriate. In particular embodiments, storage 406 is non-volatile, solid-state memory. In particular embodiments, storage 406 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 406 taking any suitable physical form. Storage 406 may include one or more storage control units facilitating communication between processor 402 and storage 406, where appropriate. Where appropriate, storage 406 may include one or more storages 406. Although this disclosure describes and illustrates particular storage, this disclosure contemplates any suitable storage.

In particular embodiments, I/O interface 408 includes hardware, software, or both, providing one or more interfaces for communication between computer system 400 and one or more I/O devices. Computer system 400 may include one or more of these I/O devices, where appropriate. One or more of these I/O devices may enable communication between a person and computer system 400. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 408 for them. Where appropriate, I/O interface 408 may include one or more device or software drivers enabling processor 402 to drive one or more of these I/O devices. I/O interface 408 may include one or more I/O interfaces 408, where appropriate. Although this disclosure describes and illustrates a particular I/O interface, this disclosure contemplates any suitable I/O interface.

In particular embodiments, communication interface 410 includes hardware, software, or both providing one or more interfaces for communication (such as, for example, packet-based communication) between computer system 400 and one or more other computer systems 400 or one or more networks. As an example and not by way of limitation, communication interface 410 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 410 for it. As an example and not by way of limitation, computer system 400 may communicate with an ad hoc network, a personal area network (PAN), a local area network (LAN), a wide area network (WAN), a metropolitan area network (MAN), body area network (BAN), or one or more portions of the Internet or a combination of two or more of these. One or more portions of one or more of these networks may be wired or wireless. As an example, computer system 400 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 400 may include any suitable communication interface 410 for any of these networks, where appropriate. Communication interface 410 may include one or more communication interfaces 410, where appropriate. Although this disclosure describes and illustrates a particular communication interface, this disclosure contemplates any suitable communication interface.

In particular embodiments, bus 412 includes hardware, software, or both coupling components of computer system 400 to each other. As an example and not by way of limitation, bus 412 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 412 may include one or more buses 412, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

This scope of this disclosure encompasses all changes, substitutions, variations, alterations, and modifications to the example embodiments herein that a person having ordinary skill in the art would comprehend. The scope of this disclosure is not limited to the example embodiments described or illustrated herein. Moreover, although this disclosure describes or illustrates respective embodiments herein as including particular components, elements, functions, operations, or steps, any of these embodiments may include any combination or permutation of any of the components, elements, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative.

What is claimed is:

1. A method comprising:
by one or more computing devices of a mobile-payment provider, receiving, from a client device, a request to verify a client-side transaction record identifying a transaction involving a user of the client device;
by the one or more computing devices, verifying that the transaction identified in the client-side transaction record is also identified in a payment-network transaction record that is separate from the client-side transaction record;
by the one or more computing devices, in response to verifying that the transaction identified in the client-side transaction record is also identified in the payment-network transaction record, publishing a verification of the transaction record; and
by the one or more computing devices, sending, to the client device, a uniform resource identifier (URI) corresponding to a web location that includes the published verification of the transaction record.

2. The method of claim 1, further comprising:
receiving a request from a third-party entity to access the published transaction-record verification from the URI; and
providing the published transaction-record verification to the third-party entity.

3. The method of claim 2, wherein the request to access the published transaction-record verification is generated in response to a request from the user to generate user content regarding the transaction.

4. The method of claim 3, wherein the user content regarding the transaction comprises a review of a product or service associated with the transaction, wherein the review is to be displayed on a website of the third-party entity.

5. The method of claim 1, wherein:
the transaction is a previously completed purchase that was initiated by the user of the client device;
the transaction comprises a transmission of a token from the client device to a payment network, wherein the token represents a payment card of the user; and
the client-side transaction record was previously received by the client device after successful completion of the purchase.

6. The method of claim 1, wherein the client-side transaction record comprises:
an identifier of the transaction;
a name or identifier of the user;
a date or time of the transaction;
a location of the client device when the transaction was initiated or completed;
an amount of the transaction;
a description of a good or service received in the transaction;
a name, identifier, website, or location of a merchant that provided the received good or service;
a name or identifier of the mobile-payment provider;
a name or identifier of a payment network involved in the transaction; or
information associated with a payment card associated with the transaction.

7. The method of claim 1, wherein the request to verify the client-side transaction record comprises:
an identifier of the transaction;
a name or identifier of the user;
a date or time of the transaction;
a location of the client device when the transaction was initiated or completed;
an amount of the transaction;
a description of a good or service received in the transaction;
a name, identifier, website, or location of a merchant that provided the received good or service;
a name or identifier of the mobile-payment provider;
a name or identifier of a payment network involved in the transaction;
information associated with a payment card associated with the transaction;
a rating or review of the received good or service; or
a multimedia file associated with the transaction.

8. The method of claim 1, wherein the request to verify the client-side transaction record is sent by a mobile-payment application running on the client device; and
further comprising verifying that the mobile-payment application is valid.

9. The method of claim 8, wherein verifying that the mobile-payment application is valid comprises performing a remote attestation of the mobile device.

10. The method of claim 8, wherein verifying that the transaction identified in the client-side transaction record is also identified in the payment-network transaction record is based at least in part on verifying that the mobile-payment application is valid.

11. The method of claim 1, wherein verifying that the transaction identified in the client-side transaction record is also identified in the payment-network transaction record comprises comparing information in the request to verify the client-side transaction record with other information collected or maintained by the mobile-payment provider

12. The method of claim 1, wherein verifying that the transaction identified in the client-side transaction record is also identified in the payment-network transaction record comprises:
sending information associated with the client-side transaction record to a payment network associated with the transaction; and
receiving from the payment network an indication that the information associated with the client-side transaction record matches related information in the payment-network transaction record.

13. The method of claim 1, wherein publishing the transaction-record verification comprises publishing the transaction-record verification to a website of the mobile-payment provider.

14. The method of claim 1, wherein the published transaction-record verification indicates that the client-side transaction record is valid.

15. The method of claim 1, further comprising sending information associated with the transaction to a third-party entity.

16. The method of claim 1, further comprising publishing user content with an embedded link to the published transaction-record verification.

17. One or more non-transitory computer-readable storage media embodying instructions that are operable when executed to:
receive, from a client device, a request to verify a client-side transaction record identifying a transaction involving a user of the client device;
verify that the transaction identified in the client-side transaction record is also identified in a payment-network transaction record that is separate from the client-side transaction record;
in response to verifying that the transaction identified in the client-side transaction record is also identified in the payment-network transaction record, publish a verification of the transaction record; and
send, to the client device, a uniform resource identifier (URI) corresponding to a web location that includes the published verification of the transaction record.

18. The media of claim 17, wherein the instructions are further operable when executed to:
receive a request from a third-party entity to access the published transaction-record verification from the URI; and
provide the published transaction-record verification to the third-party entity.

19. The media of claim 17, wherein the user content regarding the transaction comprises a review of a product or service associated with the transaction, wherein the review is to be displayed on a website of the third-party entity.

20. An apparatus comprising:
one or more non-transitory computer-readable storage media embodying instructions; and
one or more processors coupled to the storage media and configured to execute the instructions to:
receive, from a client device, a request to verify a client-side transaction record identifying a transaction involving a user of the client device;
verify that the transaction identified in the client-side transaction record is also identified in a payment-network transaction record that is separate from the client-side transaction record;
in response to verifying that the transaction identified in the client-side transaction record is also identified in the payment-network transaction record, publish a verification of the transaction record; and
send, to the client device, a uniform resource identifier (URI) corresponding to a web location that includes the published verification of the transaction record.
